(19) United States
(12) Patent Application Publication
(10) Pub. No.: US 2005/0172034 A1
(43) Pub. Date: Aug. 4, 2005

(54) Method and system for managing programs for web service system

(75) Inventors: Nobuyoshi Sakai, Yokohama (JP); Atsushi Ohtake, Yokohama (JP); Jun Sugihara, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/969,101

(22) Filed: Oct. 19, 2004

(30) Foreign Application Priority Data
Feb. 3, 2004 (JP) 2004-026642

(51) Int. Cl. G06F 15/16; G06F 17/30

(52) U.S. Cl. 709/250; 710/8

(57) ABSTRACT

When a message is transmitted to an information processing device from a communication unit, the method of this invention receives a response from the destination information processing device by the communication unit and checks whether an error has occurred which was caused by a change made to the interface definition information representing an interface with the information processing device. In the event of an error caused by a change made to the interface definition information, the method of this invention test-transmits to the information processing device from the communication unit a message to identify an input type at a location of that change. According to the location of change and a result of test transmission, the method of this invention changes a content of a program on a memory unit which transmits the messages to the information processing device.

### INCORPORATION BY REFERENCE

The present application claims priority from Japanese application JP2004-026642 filed on Feb. 3, 2004, the content of which is hereby incorporated by reference into this application.

### BACKGROUND OF THE INVENTION

The present invention relates to a program management technology for managing changes made to programs or objects.

In recent years, Web services (functions realized by executing programs and objects), or distributed object technologies using Internet, are attracting attention. Fundamental technologies for Web services include SOAP (Simple Object Access Protocol), WSDL (Web Service Description Language) and UDDI (Universal Description, Discovery, and Integration) (refer, for example, to David A. Chappell, et al, “Java Web Services” published by O'Reilly & Associates, Inc., 2002. 3, pp. 3-7).

SOAP defines an envelope structure for use in structured document exchange. Structured documents described according to this definition are called SOAP messages, and client/server programs using Web services perform communication using SOAP messages (see, for example, David A. Chappell, et al, “Java Web Services” published by O'Reilly & Associates, Inc., 2002. 3, pp. 25-53).

WSDL is a structured document format to define interfaces of Web services. Web services use WSDL files as interfaces and communicate using SOAP messages (see, for example, David A. Chappell, et al, “Java Web Services” published by O'Reilly & Associates, Inc., 2002. 3, pp. 72-95).

UDDI provides a global registry and standard specifications for Web services and is made public on the Internet as a registry that can be commonly shared. Thus, in client/server programs, Web services of the server program are registered with the UDDI registry so that the client program can use the Web services of the server program by discovering them in the UDDI registry (see, for example, David A. Chappell, et al, “Java Web Services” published by O'Reilly & Associates, Inc., 2002. 3, pp. 98-139).

### SUMMARY OF THE INVENTION

Let us consider a case in which a change is made to interface definition information of an access request destination in a distributed computing technology. A maintenance staff knows that a client program received an error message because the interface definition information was changed and, based on that knowledge, will modify the client program.

Such a maintenance work on the client program involves checking whether the message issued that caused the error was generated according to the pre-change interface definition information. If the generated message is found to have been generated correctly according to the pre-change interface definition information, the maintenance work retrieves post-change interface definition information and modifies the client program to issue a message according to the post-change interface definition information.

However, with the conventional method, the client program is simply generated from interface definition information and a template. Thus, even if it is known that the error that happened in the client program was caused by a change made to the interface definition information, the maintenance staff must first stop the client program temporarily, retrieve the post-change interface definition information, re-generate a template of the client program accordingly, and check a relation between the location of change made to the interface definition information and a location in the program to be changed as he or she proceed to perform the maintenance work. This process takes time.

Further, to add a script to the client program to check a content of input at the location of change requires the maintenance staff to perform a test transmission according to a check list concerning the input type at the location of change, generate an input check script according to the result of test transmission, and then add the generated input check script to the client program that was modified at the location of change.

An object of this invention is to provide a technology that can solve the above-mentioned problems and which, in the event of an error caused by a change made to interface definition information, can dynamically modify a program to prevent an occurrence of that error.

In a program management device that changes a program according to a change made to the interface definition information, this invention, in the event of an error caused by a change made to the interface definition information, performs a test transmission to identify an input type at the location of change and changes the program according to a content of the change made to the interface definition information and the test result.

The program management device of this invention (this may be a computer, an information processing device, or a program and object that executes such processing) sends an access request in the form of a SOAP message to a Web service server that offers Web services (functions realized by executing programs and objects) to receive Web services.

When the access request is transmitted in the form of a SOAP message, a check is made to see if an error has occurred due to a change in interface definition information representing an interface of data and operations transferred to and from the access request destination Web service program, i.e., if an error caused by a change made to a WSDL file has occurred. If an error caused by a change made to the WSDL file is found to have occurred, a comparison is made between the pre-change WSDL file and the post-change WSDL file to find out a location of change.

Then, a SOAP message for identifying the input type at the location of change is test-transmitted to the Web service server to collect a test result indicating the type of input that can be entered at the location of change. And then a content of the SOAP message sending client program is changed according to the location of change and the result of test transmission. After the content of the SOAP message sending client program is changed according to the location of change, an input check script to check the input entered at the location of change is generated according to the test result and then added to the client program.

With this invention, in the event of an error caused by a change made to interface definition information, a program can be dynamically modified to prevent an occurrence of that error.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing an example change made to a WSDL file in an embodiment of this invention.

FIG. 2 is a diagram showing an outline of processing performed by a program management device in the embodiment.

FIG. 3 is a diagram showing detailed processing performed by the client program in the embodiment.

FIG. 4 illustrates detailed processing of a test transmission (input type check) step 3-17 in the embodiment.

FIGS. 5A-5C illustrate outlines of processing of a standard input check 4-5 and an individual category input check 4-6 in the embodiment.

FIG. 6 illustrates detailed processing of mandatory checks (5-4, 5-7 and 5-9) in the embodiment.

FIG. 7 illustrates detailed processing of a character check 5-5 in the embodiment.

FIG. 8 illustrates detailed processing of a character number check 5-6 in the embodiment.

FIG. 9 illustrates detailed processing of a range check 5-8 in the embodiment.

FIG. 10 illustrates detailed processing of a type check 5-10 in the embodiment.

FIG. 11 illustrates detailed processing of a client program change 3-18 in the embodiment.

FIG. 12 illustrates an example JSP changed by the program management device in the embodiment.

FIG. 13 illustrates details of input check script addition processing 11-4 in the embodiment.

FIG. 14 illustrates details of input character check script addition processing 13-3 in the embodiment.

FIG. 15 illustrates an outline configuration of a program management system in the embodiment.

FIG. 16 illustrates a hardware configuration of the program management device in the embodiment.

### DESCRIPTION OF THE EMBODIMENT

One embodiment of a program management device will be described which, in response to a change made to interface definition information, changes a client program and then adds to the client program an input check script that checks a content of input at that location of change.

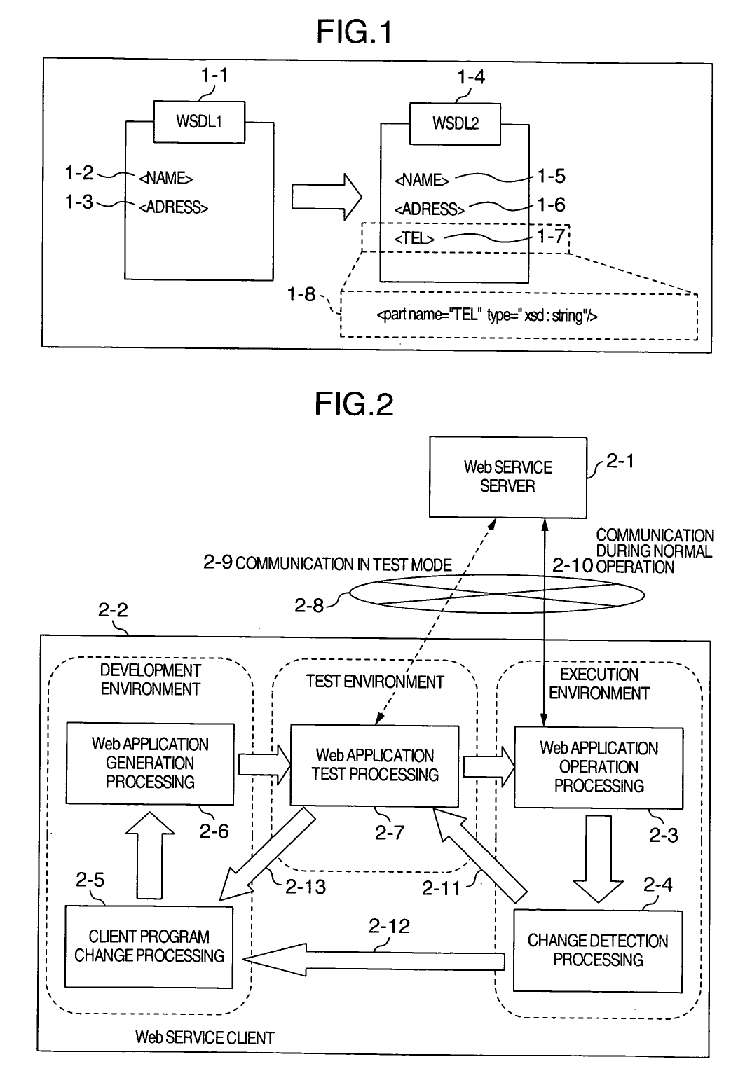

FIG. 1 shows an example of change made to a WSDL file in this embodiment. Let us consider a case where WSDL storage location information representing an interface of a Web service (a function realized by executing a program or object) is changed from WSDL1 (1-1) to WSDL2 (1-4), as shown in FIG. 1. The Web service before the change accepts only name and address as user information but, after the change, it also accepts an input of telephone number in addition to name and address. That is, only <NAME> and <ADDRESS> tags (1-2, 1-3) are embedded in WSDL1 whereas WSDL2 contains <NAME>, <ADDRESS> and <TEL> tags (1-5, 1-6, 1-7), as shown in FIG. 1. More specifically, a line 1-8 is added to an interface of the Web service.

FIG. 2 illustrates an outline of processing performed by the program management device of this embodiment. Although in this embodiment the explanation concerns programs, it can also be applied to objects.

As shown in FIG. 2, normal operations are performed by a SOAP message communication 2-10 between a Web service server 2-1 and Web application operation processing 2-3 on a Web service client 2-2. In this embodiment, the Web service client 2-2 operates as a program management device that changes the client program according to changes made to the interface definition information. The Web service server 2-1 and the Web service client 2-2 shown in FIG. 2 may be computers, information processing devices, or programs or objects that perform such processing.

In the Web service server 2-1, if WSDL, an interface of Web service, is changed as shown in FIG. 1 and a SOAP message is sent from the Web service client 2-2, the Web service server 2-1 returns a fault message because the interface of the SOAP message is different from the current interface. A fault code in this case is SOAP-ENV: Client.

When the Web application operation processing 2-3 on the Web service client 2-2 side receives the fault message, change detection processing 2-4 detects a change in the interface WSDL on the Web service server 2-1 side and identifies a location of the change in WSDL.

Then, this embodiment either performs a test on an input type of the changed interface by Web application test processing 2-7 (2-11) or proceeds with client program change processing 2-5 (2-12). Which of these processing is to be executed is set beforehand in a setting file and a decision is made according to a value in the setting file.

If the Web application test processing 2-7 is invoked, it adds a content of the test to be performed on the input type of the interface to the message and communicates it to the Web service server 2-1 in a test mode 2-9.

The client program change processing 2-5 changes the client program according to information on the identified location of change and the result of Web application test processing 2-7. If the test has not been performed, the client program change processing 2-5 changes the client program based only on the identified location of change.

Web application generation processing 2-6 integrates the program changed by the client program change processing 2-5 to re-create a Web application program. Then, the Web application test processing 2-7 performs the test transmission again using the integrated Web application program, analyzes a response to the test transmission to see if an error occurs, and decides whether to resume the Web application operation processing 2-3 or to stop the operation and inform the error to an administrator.

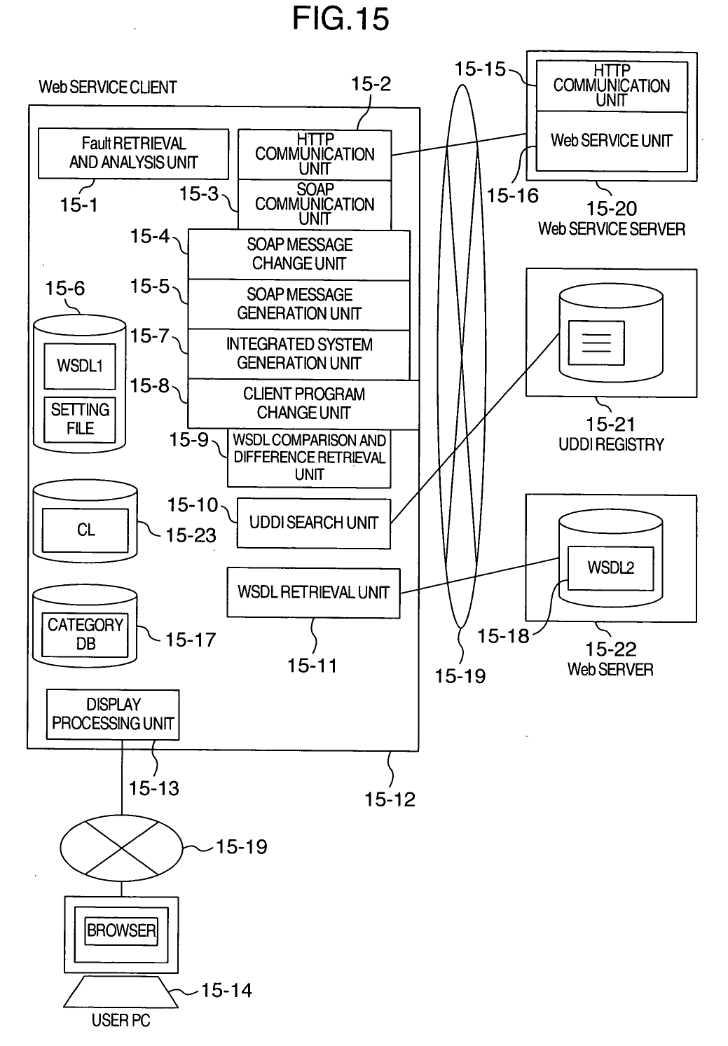

FIG. 15 shows an outline configuration of a program management system of this embodiment. As shown in FIG. 15, the Web service client of this embodiment has a fault retrieval and analysis unit 15-1, a HTTP communication unit 15-2, a SOAP communication unit 15-3, a SOAP message change unit 15-4, a SOAP message generation unit 15-5, an integrated system generation unit 15-7, a client program change unit 15-8, a WSDL comparison and difference retrieval unit 15-9, a UDDI search unit 15-10, a WSDL retrieval unit 15-11, and a display unit 15-13.

The fault retrieval and analysis unit 15-1, when a message is sent to a Web service server 15-20 through a message communication device, receives a response from the Web service server 15-20 through the communication device and, in the event of an error, retrieves and analyzes a fault message to check if the error is caused by a change made to interface definition information representing the interface of the Web service server 15-20.

The HTTP communication unit 15-2 communicates with the Web service server 15-20 over HTTP. The SOAP communication unit 15-3 performs transmission and reception of SOAP messages including test mode transmissions. In the event of an error caused by a change made to the interface definition information, this unit sends a test message for checking an input type at the location of change to the Web service server 15-20 through the communication device.

The SOAP message change unit 15-4, in the event of an error caused by a change made to the interface definition information, adds a header element to the input type check message. The SOAP message generation unit 15-5 receives data from a browser of a user PC 15-14 through the display unit 15-13 and creates a SOAP message.

The integrated system generation unit 15-7, when an error is caused by a change made to the interface definition information and the client program is changed accordingly, recompiles all components and rebuilds the Web application program.

The client program change unit 15-8 changes the content of the client program, which sends messages to the Web service server 15-20, on a storage device such as memory and magnetic disk drive according to the location of change and the result of test transmission.

The WSDL comparison and difference retrieval unit 15-9, when an error is caused by a change made to the interface definition information, compares the pre-change WSDL and the post-change WSDL and retrieves a difference. The UDDI search unit 15-10 searches through a UDDI registry 15-21 for WSDL storage location information.

The WSDL retrieval unit 15-11 retrieves WSDL from a Web server 15-22 based on the WSDL storage location information obtained. The display unit 15-13 displays a Web page on the browser of the user PC 15-14 as a result of the operation of the Web application programs including the client program and receives an input from the browser for transfer to the SOAP message generation unit 15-5.

A program to make the Web service client function as the fault retrieval and analysis unit 15-1, HTTP communication unit 15-2, SOAP communication unit 15-3, SOAP message change unit 15-4, SOAP message generation unit 15-5, integrated system generation unit 15-7, client program change unit 15-8, WSDL comparison and difference retrieval unit 15-9, UDDI search unit 15-10, WSDL retrieval unit 15-11 and display unit 15-13 is recorded in a recording medium such as CD-ROM, installed in a magnetic disk and then loaded into memory for execution. The recording medium in which the program is recorded may be other media than the CD-ROM. The program may be installed from the recording medium into an information processing device for execution or the recording medium may be accessed via network to use the program.

The Web service client 15-12, the Web service server 15-20, the UDDI registry 15-21, the Web server 15-22 and the user PC 15-14 shown in FIG. 15 are computers connected to a network 15-19.

While this embodiment does not specify a particular communication means between the servers and the client, the following description assumes that communication is established over the Internet according to HTTP (HyperText Transfer Protocol).

That is, the Web service client 15-12, the Web service server 15-20 and the UDDI registry 15-21 have a function of HTTP servers. The Web service client 15-12 communicates with the user PC 15-14 through the Web browser; the Web service server 15-20 communicates with the Web service client 15-12 using SOAP messages; and the UDDI registry 15-21 communicates with the Web service client 15-12 using SOAP messages.

The Web service server 15-20 has a HTTP communication unit 15-15 and a Web service unit 15-16 on memory. The HTTP communication unit 15-15 communicates with the Web service client 15-12 over HTTP; and the Web service unit 15-16 receives SOAP messages from the Web service client 15-12 and, according to the messages, performs corresponding processing to offer Web services. The UDDI registry 15-21 holds Web services information, such as WSDL storage location, and the Web server 15-22 holds information on WSDL.

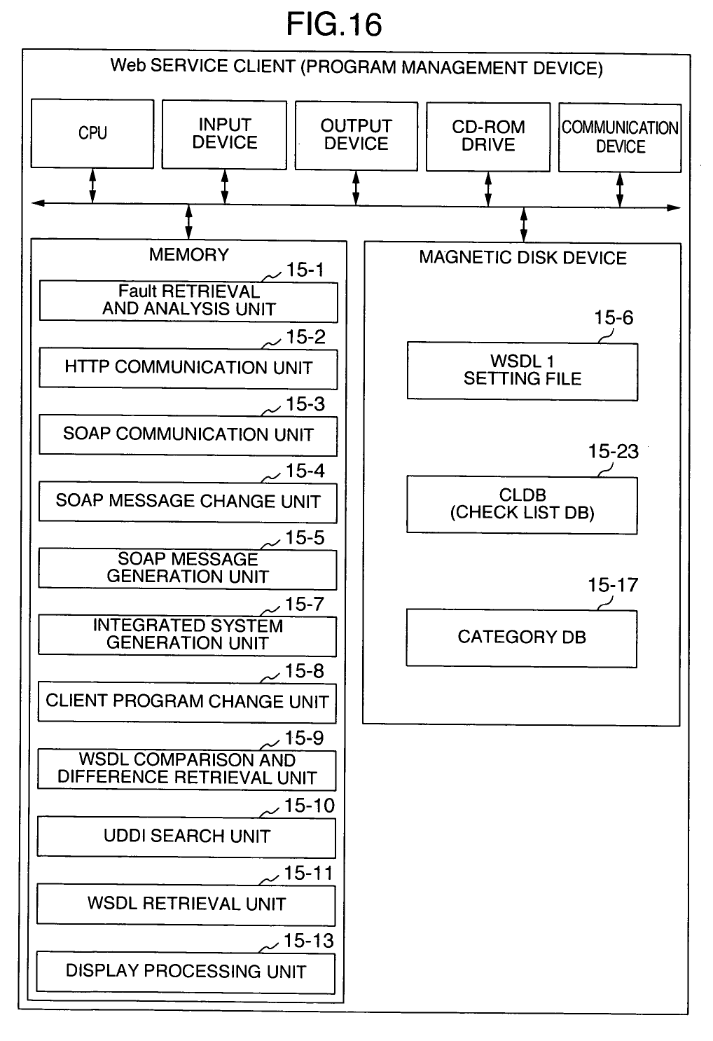

FIG. 16 shows a hardware configuration of the program management device of this embodiment. As shown in FIG. 16, the Web service client 15-12, or the program management device of this embodiment, has on memory the fault retrieval and analysis unit 15-1, HTTP communication unit 15-2, SOAP communication unit 15-3, SOAP message change unit 15-4, SOAP message generation unit 15-5, integrated system generation unit 15-7, client program change unit 15-8, WSDL comparison and difference retrieval unit 15-9, UDDI search unit 15-10, WSDL retrieval unit 15-11, and display unit 15-13.

The Web service client 15-12 also has installed on a magnetic disk drive a client DB 15-6 having WSDLs and setting files before and after the change, a category DB 15-17 holding category information, and a CLDB 15-23 having a check list used to check inputs. The Web service client 15-12 communicates with other processing devices such as Web service server 15-20 through the communication device.

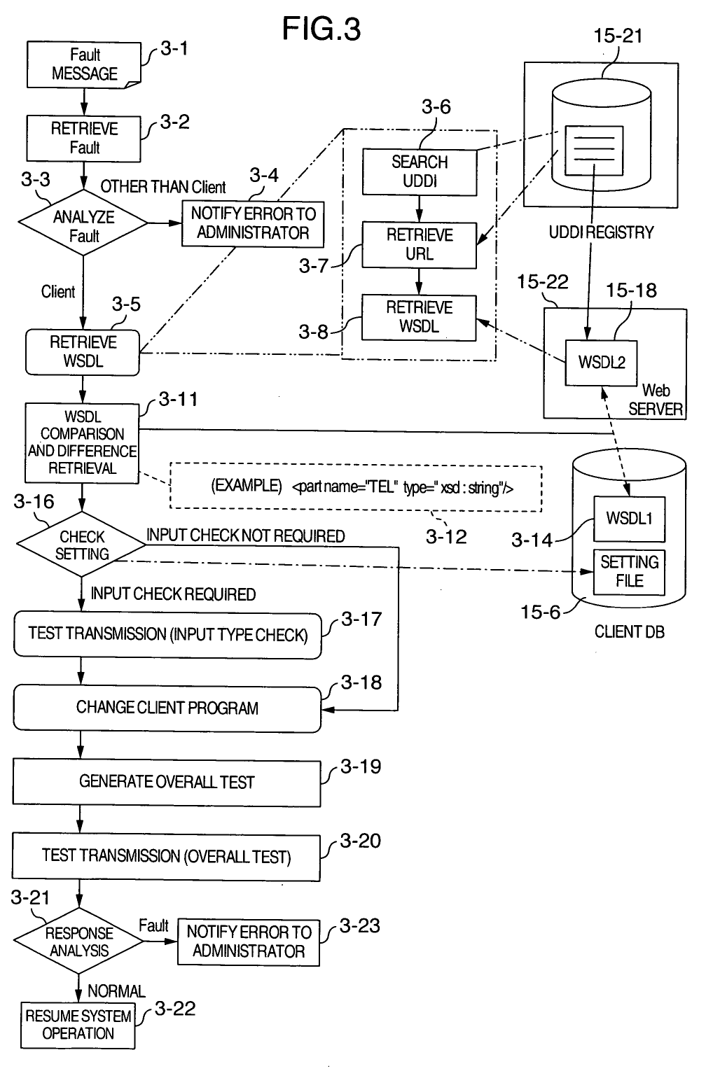

FIG. 3 shows details of processing on the client program side according to this embodiment. In the following, the details of processing on the Web service client 15-12 side according to this embodiment will be described by referring to FIG. 15 and FIG. 3.

The HTTP communication unit 15-2 and the SOAP communication unit. 15-3 in the Web service client 15-12, the program management device of this embodiment, issue an access request in the form of a SOAP message to the Web service server 15-20 in order to receive Web services from the Web service server 15-20.

The fault retrieval and analysis unit 15-1 in the Web service client 15-12, when a SOAP message is sent from the communication device to the Web service server 15-20, receives a response from the Web service server 15-20 through the communication device and checks if the response is a fault message 3-1. If the response received is a fault message 3-1, the fault retrieval and analysis unit 15-1 stores the fault message 3-1 in memory (3-2).

Next, the fault retrieval and analysis unit 15-1 analyzes the fault message to determine whether, when the access request was issued in the form of SOAP message, an error was caused by a change in the WSDL file representing an interface of data and operations transferred to and from the Web service unit 15-16, which is a destination of access (3-3). That is, the fault message analysis processing 3-3 looks up the fault message 3-1 stored in memory and checks if a content of fault code tag is SOAP-ENV: Client. If so, the fault retrieval and analysis unit 15-1 retrieves WSDL and, if not, stops the operation of the Web application program and displays an error page on an output device on the administrator side to inform him of the error (3-4).

In a WSDL retrieval processing 3-5 the UDDI search unit 15-10 searches through the UDDI registry 15-21 for Web services by using the Web services search conditions stored beforehand in the client DB 15-6 (3-6) and retrieves post-change WSDL storage location information from the UDDI registry 15-21 (3-7).

Next, in a WSDL retrieval processing 3-8 the WSDL retrieval unit 15-11 accesses the Web server 15-22 using a URL of the storage location information obtained, retrieves the post-change WSDL2 (15-18) from the Web server 15-22 through the communication device and stores it in memory.

In a WSDL comparison and difference retrieval processing 3-11, the WSDL comparison and difference retrieval unit 15-9 compares on the memory the post-change WSDL2 (15-18) obtained and the pre-change WSDL1 (3-14) stored in the client DB 15-6 and retrieves a difference between them representing a location of change. In this embodiment, the difference retrieved may, for example, be as shown in WSDL difference 3-12.

In a setting check processing 3-16 the SOAP communication unit 15-3 reads a value of the setting file from the client DB 15-6. If the value thus read out represents a setting requiring an input check, this unit 15-3 performs a test transmission (input type check) processing 3-17 and then executes client program change processing 3-18. If the read value represents a setting not requiring an input check, the unit 15-3 proceeds to execute the client program change processing 3-18 without performing the test transmission.

In the test transmission (input type check) processing 3-17 the SOAP communication unit 15-3 performs a test transmission to check an input specification in the WSDL difference 3-12 on the Web service server 15-20 side.

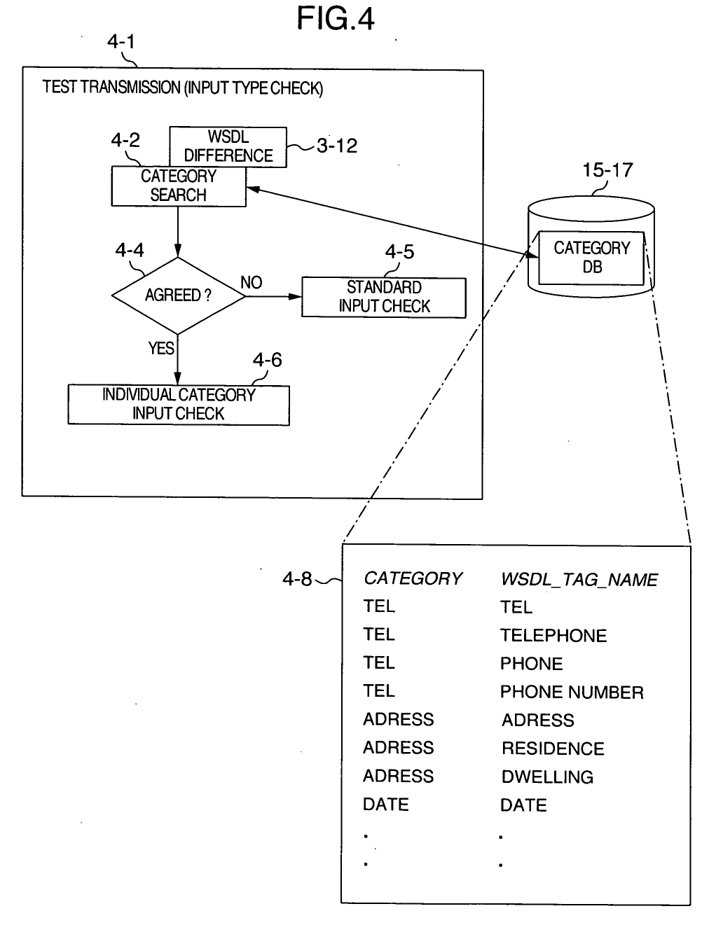

FIG. 4 shows details of the test transmission (input type check) processing 3-17 in this embodiment. As shown in FIG. 4, in the test transmission (input type check) 4-1, the SOAP communication unit 15-3 first performs a category search 4-2 on the WSDL difference 3-12 obtained by the WSDL comparison and difference retrieval processing 3-11 to search the category DB 15-17 stored on the Web service client 15-12 side.

The category search 4-2 searches through a WSDL_TAG_NAME column in a category table 4-8 for the difference value and reads out a value of CATEGORY column that corresponds to that difference value. For example, if a tag name in the WSDL difference is “PHONE”, then a value in the CATEGORY column, “TEL”, corresponding to the tag name is read out.

In next agreement decision processing 4-4, a check is made to see if a value of WSDL_TAG_NAME that agrees with the tag name in the WSDL difference was found in the category search 4-2. If so, the processing 4-4 decides that there is a category agreement and proceeds to an individual category input check 4-6. If not, the processing moves to a standard input check 4-5. Suppose, for instance, the tag name of the WSDL difference is “AGE” and a value corresponding to the tag name “AGE” does not exist in WSDL_TAG_NAME column. In that case, it is decided that there is no category agreement and the standard input check 4-5 is performed. In the case where the tag name of the WSDL difference 3-12 in this embodiment is “TEL”, the individual category input check 4-6 is performed for “TEL” in CATEGORY column.

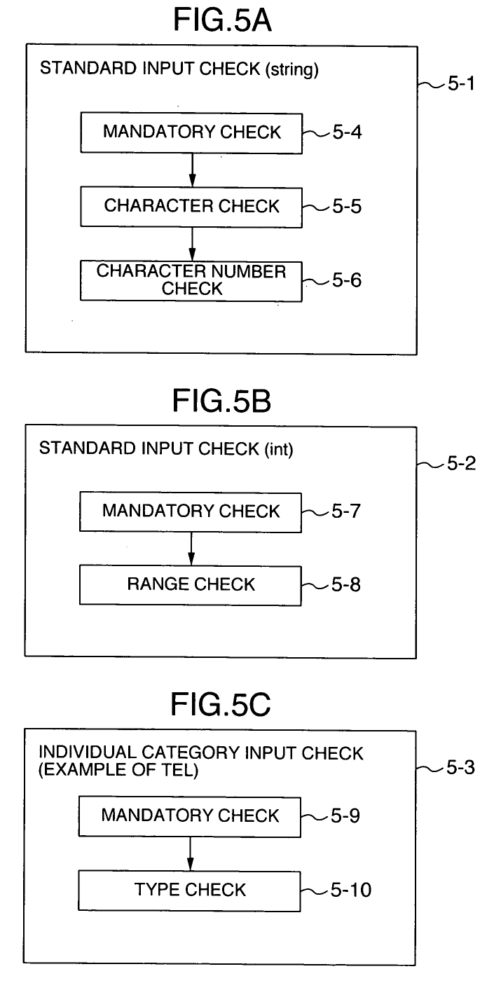

FIGS. 5A, 5B and 5C show an outline of processing of the standard input check 4-5 and the individual category input check 4-6. As shown in FIG. 5, in the standard input check 4-5 the SOAP communication unit 15-3 performs a standard input check (string) 5-1 or a standard input check (int) 5-2 depending on a value of type of the WSDL difference. The standard input check (string) 5-1 performs a mandatory check 5-4, a character check 5-5 and a character number check 5-6; and the standard input check (int) 5-2 performs a mandatory check 5-7 and a range check 5-8.

Shown in an individual category input check 5-3 of FIG. 5C is an example case where the category is “TEL”. In the individual category input check processing, it is assumed that a different check can be selected for a different category. In the case of “TEL” a mandatory check 5-9 and a type check 5-10 are performed.

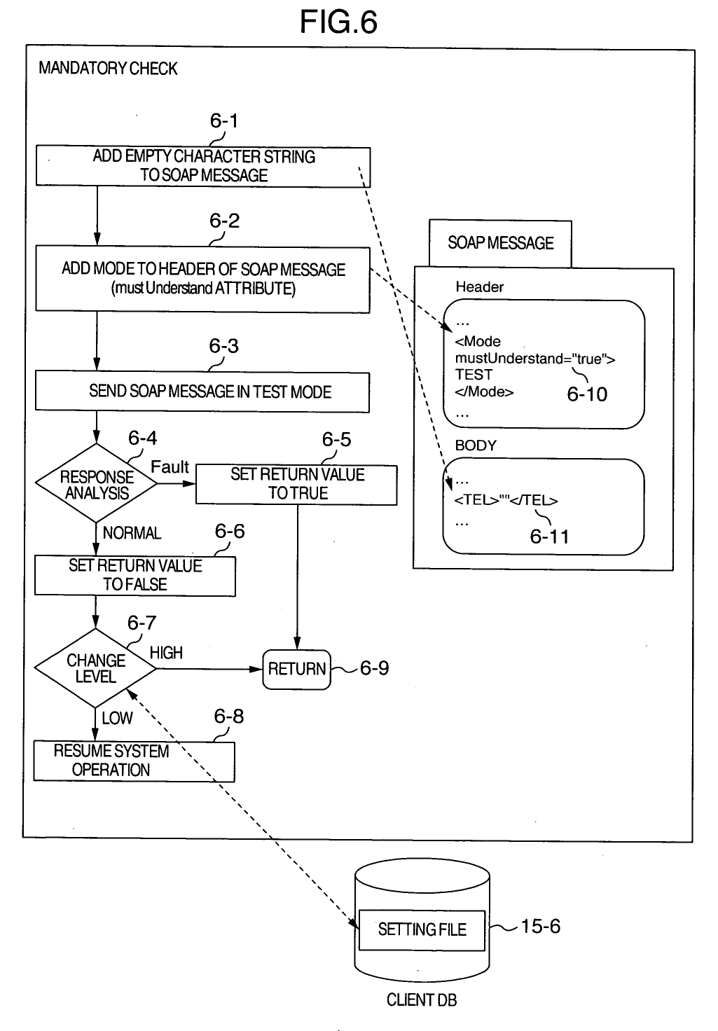

FIG. 6 shows details of processing of the mandatory checks (5-4, 5-7 and 5-9) of this embodiment. As shown in FIG. 6, in the mandatory checks, the SOAP communication unit 15-3 test-transmits to the Web service server 15-20 through the communication device an empty character string as a content of the tag to be added at the location of change to check if the content of the tag is essential at the time of message transmission.

First, in the processing that adds an empty character string to the SOAP message, 6-1, the SOAP communication unit 15-3 identifies a tag to be added (here TEL) from the difference obtained, sets as a content of tag an empty character string (“”), as shown in an example setting 6-11, and adds the tag and its content to the body element of the SOAP message that was faulted. In this embodiment, to modify such a SOAP message at time of occurrence of error, the SOAP message sent from the Web service client 15-12 to the Web service server 15-20 is temporarily stored in memory.

Next, the SOAP message is transmitted in a test mode. This is done as follows. First, the SOAP communication unit 15-3 adds a mode tag to a header of the SOAP message (6-2). Here, as shown in an example setting 6-10, an attribute of the mode tag is set as mustUnderstand attribute so that the Web service server 15-20 returns an error when it cannot understand the mode tag. A content of the mode tag is set to “TEST”. In this embodiment, it is assumed that the Web service server 15-20 also has a function to interpret this header so that, when the content of the mode tag is “TEST”, it operates in a test mode to check if the SOAP message sent from the client side is normal and return a response accordingly without performing operations such as actual reservation and ordering.

Next, the SOAP communication unit 15-3 sends the modified SOAP message to the Web service server 15-20 through the communication device (6-3), receives a response and analyzes it (6-4). In this mandatory check, if a normal response is returned, this means that the Web service server 15-20 accepts an empty string for the added tag (in this case, TEL), i.e., the content of the added tag is not essential. If a fault message is returned, the Web service server 15-20 does not accept an empty string for the added tag, i.e., the content of the added tag is mandatory.

If the response analysis 6-4 finds that a normal response was returned, a return value is set to false (6-6) and a modification level of the setting file stored in the client DB 15-6 is checked (6-7). Then, if the modification level representing a necessity of its change is set “low”, the system operation is resumed (6-8); and if the modification level is “high”, the mandatory check processing is exited and the control returns to the main processing that called the mandatory check (6-9). If the response analysis 6-4 finds that a fault message was returned, the return value is set to true (6-5) and the mandatory check processing is exited and the control returns to the main processing (6-9).

As described above, whether the content of a tag to be added is essential or not can be checked by identifying the tag to be added, setting an empty character string as the content of the tag, adding the tag and its content to the body of the message and performing a test transmission concerning the input type of the access request.

Further, in resuming the system operation, the SOAP message output from the Web service client 15-12 is modified, as by adding or deleting a body element corresponding to the difference, and the modified SOAP message is transmitted to the Web service server 15-20.

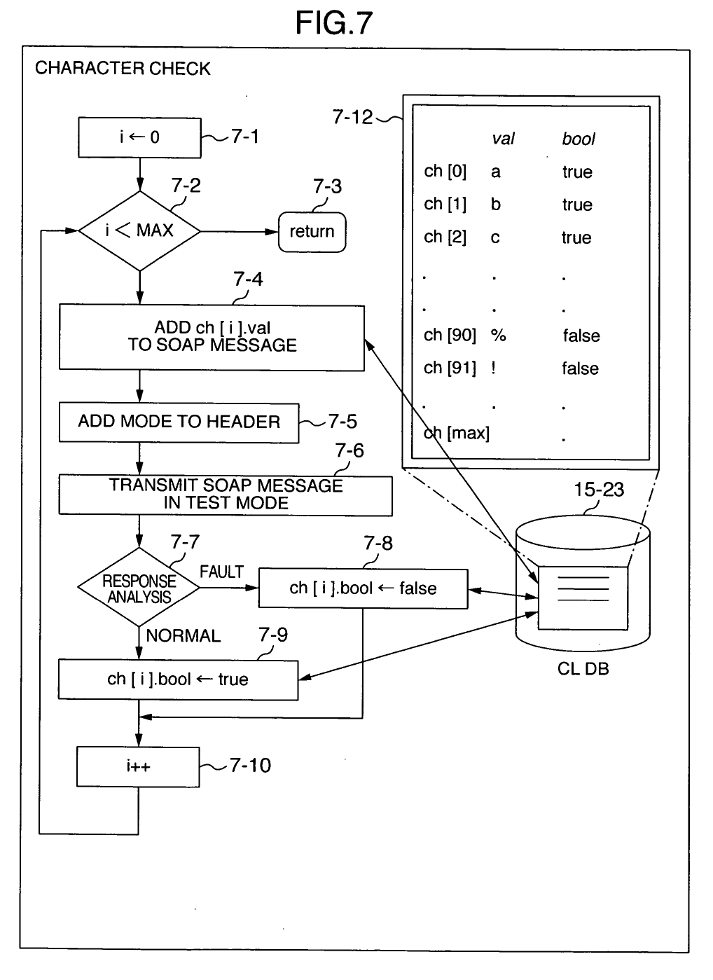

FIG. 7 shows details of processing performed in the character check 5-5 in this embodiment. As shown in FIG. 7, in the character check 5-5 the SOAP communication unit 15-3 test-transmits a character string of a predetermined kind as a content of the tag to be added at the location of change to the Web service server 15-20 through the communication device to determine the characters that can be sent as a content of the tag at time of message transmission and then stores information representing transmittable characters in a check list (table 7-12) in the CLDB 15-23 of the storage device.

In the character check 5-5, the SOAP communication unit 15-3 newly defines an integer variable i and substitutes 0 for i (7-1) and, while i is smaller than max, repeats the subsequent processing. At step 7-2, when i is equal to or larger than max, the character check processing is exited (7-3).

Here, the value of max is the number of character kinds stored in the CLDB 15-23, a database storing the check list. In val column in the table 7-12 of the CLDB 15-23 characters to be checked are stored; and in bool column bool values determined by the character check are entered. These values ch[0], ch[1], . . . , ch[max] in the table are used as an object arrangement variable with values in val and bool columns as its attributes and are held in memory at the start of system operation. In subsequent processing, the value of the variable is manipulated.

In the processing that adds ch[i].val to a SOAP message, 7-4, the SOAP communication unit 15-3 identifies a tag to be added from the difference obtained (here, TEL), sets the value of ch[i].val as a content of the tag, and adds the tag and its content to the body element of the SOAP message that was faulted.

Next, a mode tag is added to the header of the SOAP message (7-5) and the SOAP message is transmitted in a test mode (7-6). Then, a response to the message is analyzed (7-7). If a normal response is returned, true is substituted for the value of ch[i].bool (7-9); and if a fault is returned, false is substituted for the value of ch[i].bool (7-8). Then, the value of the variable i is incremented by one and the processing returns to step 7-2.

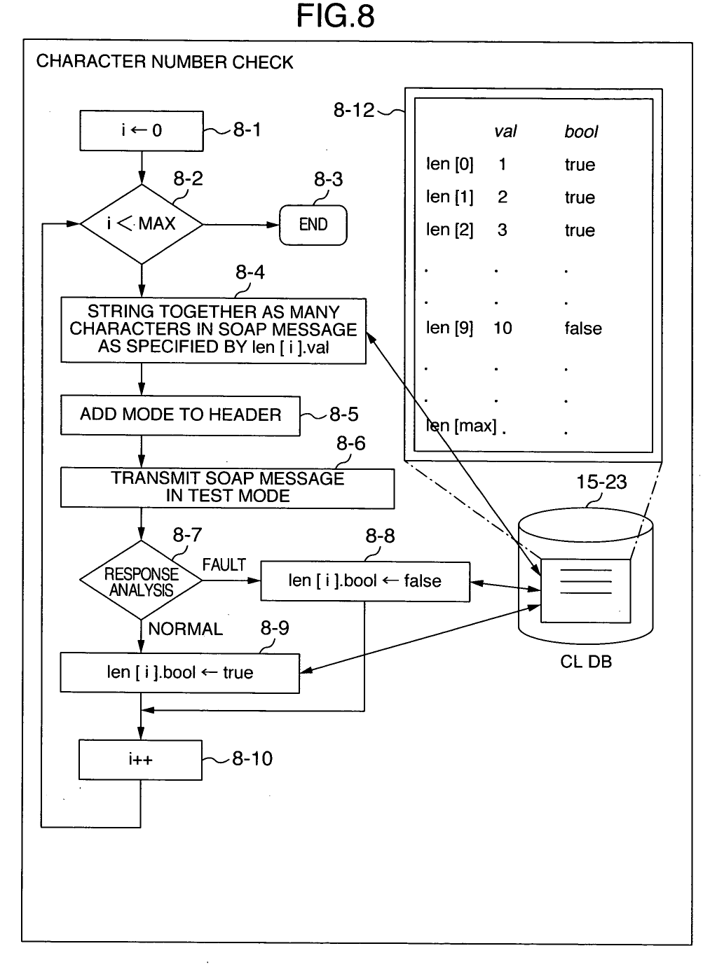

FIG. 8 shows details of processing performed by the character number check 5-6 of this embodiment. As shown in FIG. 8, in the character number check 5-6 the SOAP communication unit 15-3 test-transmits a predetermined number of characters as a content of the tag to be added at the location of change to the Web service server 15-20 through the communication device to check the number of characters that can be transmitted as the content of the tag when transmitting the message and then stores information representing the transmittable character number in the check list (table 8-12) in the CLDB 15-23 in the storage device.

In the character number check 5-6 the SOAP communication unit 15-3 newly defines an integer variable i and substitutes 0 for i (8-1) and, while i is smaller than max, repeats the subsequent processing. At step 8-2, when i is equal to or larger than max, the character number check processing is exited (8-3).

Here, the value of max is the number of character number data stored in the CLDB 15-23. In val column in the table 8-12 of the CLDB 15-23 values of character numbers to be checked are stored; and in bool column bool values determined by the character number check are entered. These values len[0], len[1], . . . , len[max] in the table are used as an object arrangement variable with values in val and bool columns as its attributes and are held in memory at the start of system operation. In subsequent processing, the value of the variable is manipulated.

In the processing that strings together the same number of characters as specified by len[i].val in the SOAP message, 8-4, the SOAP communication unit 15-3 identifies a tag to be added (here, TEL) from the WSDL difference obtained and sets as a content of the tag a string of as many predetermined characters as specified len[i].val. The characters used here are those characters of chi[i].val whose ch[i].bool value is set as true by the character check 5-5. Then, the tag and its content are added to the body element of the SOAP message.

Next, a mode tag is added to the header of the SOAP message (8-5) and the SOAP message is transmitted in a test mode (8-6). Then, a response to the message is analyzed (8-7). If a normal response is returned, true is substituted for the value of len[i].bool (8-9); and if a fault is returned, false is substituted for the value of len[i].bool (8-8). Then, the value of the variable i is incremented by one and the processing returns to step 8-2.

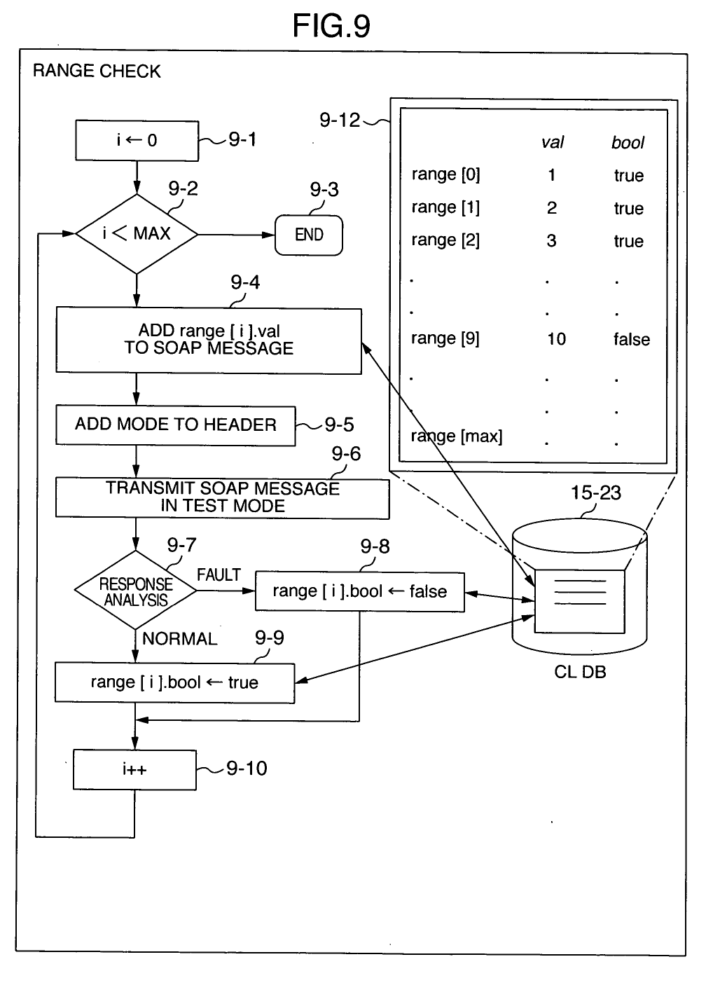

FIG. 9 shows details of processing performed by the range check 5-8 of this embodiment. As shown in FIG. 9, in the range check 5-8 the SOAP communication unit 15-3 test-transmits a predetermined value as a content of the tag to be added at the location of change to the Web service server 15-20 through the communication device to check a range of values that can be transmitted as the content of the tag when transmitting the message and then stores information representing the transmittable range of values in the check list (table 9-12) in the CLDB 15-23 in the storage device.

In the range check 5-8 the SOAP communication unit 15-3 newly defines an integer variable i and substitutes 0 for i (9-1) and, while i is smaller then max, repeats the subsequent processing. At step 9-2, when i is equal to or larger than max, the range check processing is exited (9-3).

Here, the value of max is the number of values stored in the CLDB 15-23. In val column in the table 9-12 of the CLDB 15-23 values (integer values) to be checked are stored; and in bool column bool values determined by the range check are entered. These values range[0], range[1], . . . , range[max] in the table are used as an object arrangement variable with values in val and bool columns as its attributes and are held in memory at the start of system operation. In subsequent processing, the value of the variable is manipulated.

In the processing that adds range[i].val to the SOAP message, 9-4, the SOAP communication unit 15-3 identifies a tag to be added (here, TEL) from the difference obtained, sets a value of range[i].val as a content of the tag, and adds the tag and its content to the body element of the SOAP message that was faulted.

Next, a mode tag is added to the header of the SOAP message (9-5) and the SOAP message is transmitted in a test mode (9-6). Then, a response to the message is analyzed (9-7). If a normal response is returned, true is substituted for the value of range[i].bool (9-9); and if a fault is returned, false is substituted for the value of range[i].bool (9-8). Then, the value of the variable i is incremented by one and the processing returns to step 9-2.

Table 9-12 of FIG. 9 shows a content of the table after the above processing is complete. In the example of FIG. 9, values in bool column corresponding to 1, 2, 3, . . . in val column are true; and values in bool column corresponding to 10, . . . in val column are false. This range check finds that, as a content of the added tag, integer values of 1-9 can be used but integer values equal to or greater than 10 cannot be used. As described above, the range of usable values can be checked by identifying a tag to be added, setting a value to be tested as a content of the tag, adding the tag and its content to the body of the message and performing a test transmission concerning the input type of the access request.

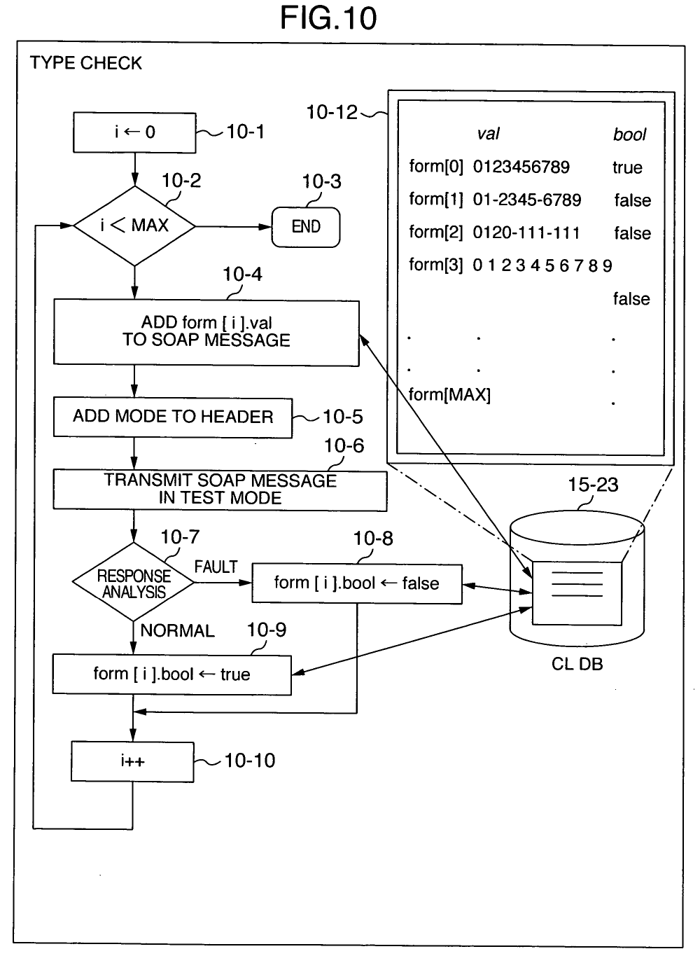

FIG. 10 shows details of processing performed by the type check 5-10 of this embodiment. As shown in FIG. 10, in the type check 5-10 the SOAP communication unit 15-3 test-transmits a predetermined type of character string as a content of the tag to be added at the location of change to the Web service server 15-20 through the communication device to check a type of character string that can be transmitted as the content of the tag when transmitting the message and then stores information representing the transmittable type of character string in the check list (table 10-12) in the CLDB 15-23 in the storage device.

In the type check 5-10 the SOAP communication unit 15-3 newly defines an integer variable i and substitutes 0 for i (10-1) and, while i is smaller then max, repeats the subsequent processing. At step 10-2, when i is equal to or larger than max, the type check processing is exited (10-3).

Here, the value of max is the number of type sample kinds stored in the CLDB 15-23. In val column in the table 10-12 of the CLDB 15-23 values of type samples (character strings) to be checked are stored; and in bool column bool values determined by the type check are entered. These values form[0], form[1], form[max] in the table are used as an object arrangement variable with values in val and bool columns as its attributes and are held in memory at the start of system operation. In subsequent processing, the value of the variable is manipulated.

In the processing that adds form[i].val to the SOAP message, 10-4, the SOAP communication unit 15-3 identifies a tag to be added (here, TEL) from the difference obtained, sets a value of form[i].val as a content of the tag, and adds the tag and its content to the body element of the SOAP message that was faulted.

Next, a mode tag is added to the header of the SOAP message (10-5) and the SOAP message is transmitted in a test mode (10-6). Then, a response to the message is analyzed (10-7). If a normal response is returned, true is substituted for the value of form[i].bool (10-9); and if a fault is returned, false is substituted for the value of form[i].bool (10-8). Then, the value of the variable i is incremented by one (10-10) and the processing returns to step 10-2.

Table 10-12 of FIG. 10 shows a content of the table after the above processing is complete. In the example of FIG. 10, a value in bool column corresponding to 0123456789 in val column is true; and values in bool column corresponding to 01-2345-6789, 0120-111-111, 0 1 2 3 4 5 6 7 8 9 in val column are false. This type check finds that, as a content of the added tag (e.g., TEL), the type of 0123456789 can be used but the types of 01-2345-6789, 0120-111-111, 0 1 2 3 4 5 6 7 8 9, . . . cannot be used. As described above, the type of character string can be checked by identifying a tag to be added, setting a type of character string to be tested as a content of the tag, adding the tag and its content to the body of the message and performing a test transmission concerning the input type of the access request.

After the test transmission (input type check) processing 3-17 has been executed as described above, the client program change unit 15-8 in the Web service client 15-12 performs the client program change processing 3-18.

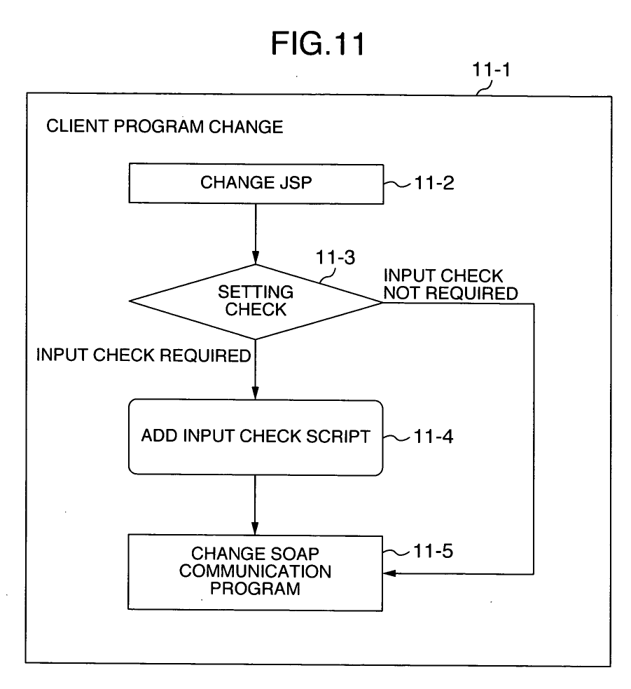

FIG. 11 shows details of the client program change processing 3-18 of this embodiment. As shown in FIG. 11, the client program change unit 15-8 modifies, on a storage device such as memory and magnetic disk drive, a content of the message transmission client program according to the location of change and the result of test transmission.

In a JSP change processing 11-2 the client program change unit 15-8 identifies a tag to be added (here, TEL) from the WSDL difference obtained and adds the input form to JSP (Java Server Pages).

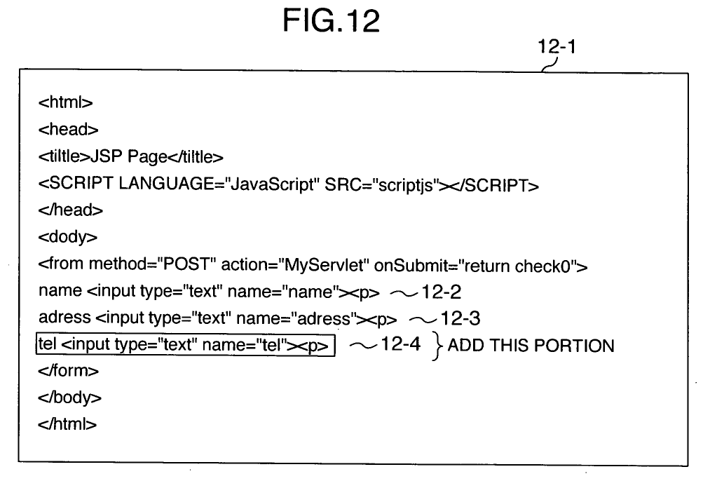

FIG. 12 shows an example JSP modified by the program management device of this embodiment. As shown in FIG. 12, the client program change unit 15-8 adds a telephone input form 12-4 to the existing input forms for name and address 12-2, 12-3.

Next, the client program change unit 15-8 performs a setting check step 11-3. The setting check step 11-3 reads a value of the setting file from the client DB 15-6. If the read value indicates a setting that requires an input check, the setting check step 11-3 performs input check script addition processing 11-4 and, if the value indicates a setting that does not require input check, moves to SOAP communication program change processing 11-5 without performing the input check script addition processing 11-4.

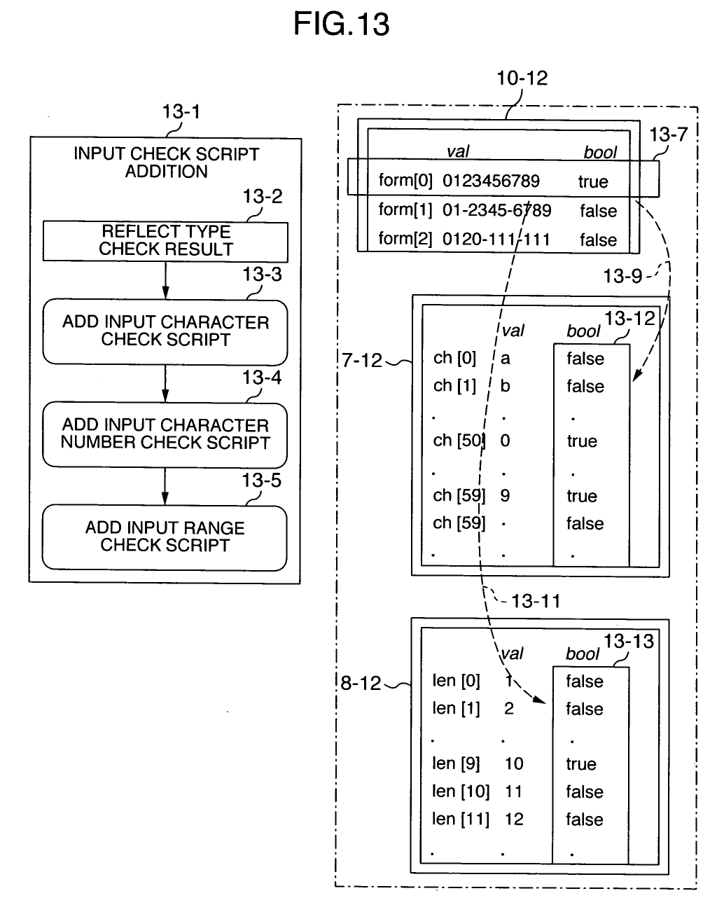

FIG. 13 shows details of the input check script addition processing 11-4. First, in type check result reflection processing 13-2 the client program change unit 15-8 identifies the type of true from the form[i].bool value in the table 10-12 representing the type check result and sets a predetermined value according to the identified type in the table 7-12 and table 8-12 for the character check and character number check, both of which checks were not performed during the type check (13-9, 13-11).

That is, from character strings of the type that was decided by the type check 5-10 to be transmittable, characters and character numbers are extracted and information representing the transmittable characters and their number is stored in the table 7-12 and table 8-12 of the check list in the CLDB 15-23 of the storage device.

For example, when performing the reflection processing using the table 10-12 representing the type check result, since the type “0123456789” is true, only those characters that appear in that type, “0” . . . “9”, are taken as true and, for the character number, only “10” which is the number of characters in that type is taken as true (13-12, 13-13).

The input character check script addition processing 13-3, input character number check script addition processing 13-4, and input range check script addition processing 13-5 each add to JSP on the storage device such as memory an input check script for checking the content of the tag added at the location of change according to the character check result, the character number check result and the range check result in the check list of the CLDB 15-23 in order to change the content of the message transmitting client program according to the result of the tests. At time of transmitting a message, the added input check script makes it possible to check whether the character string entered from an input device as the content of the tag added at the location of change conforms to the transmittable characters and the transmittable character number stored in the check list of the CLDB 15-23.

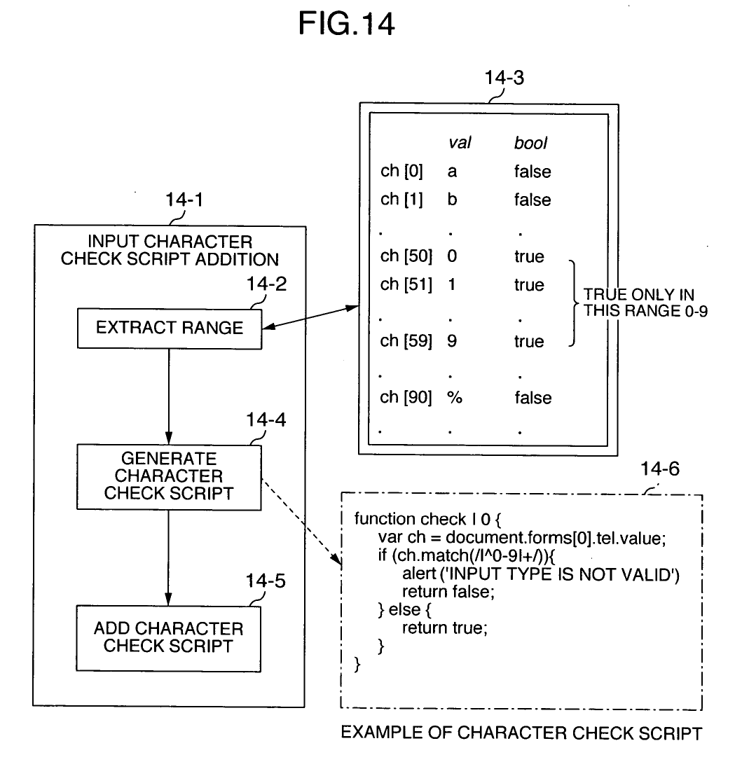

FIG. 14 shows details of the input character check script addition processing 13-3 of this embodiment. In the range extraction processing 14-2 the client program change unit 15-8 extracts a range of values in which the values of the attribute bool of the object variable ch[0], . . . , ch[max] in the table 7-12 representing the character check result are true. That is, a range of successive val column values in the table 7-12 whose corresponding bool column values are true is extracted. If there are no successive val column values whose bool column value are true and no range can be extracted, discrete val column values whose bool column values are true are individually extracted.

Next, in the character check script generation processing 14-4, a character check script is generated from the result extracted by the range extraction processing 14-2 (here, from the character range of between “0” and “9”). An example input check script 14-6 shows an example of generated script to check whether the input character is one of the characters “0” to “9”.

Next, in the character check script addition processing 14-5, the character check script generated by the character check script generation processing 14-4 is added to the client program on the storage device such as memory to change the client program.

While an example of adding a character check script to check the character kind entered has been shown here, the same procedure can also be used to add a character number check script to check the number of characters entered and to add a range check script to check the range of values entered. It is also possible to add a script that converts a full-size character to a half-size character.

After executing the client program change processing 3-18 as described above, the integrated system generation unit 15-7 of the Web service client 15-12 performs the integrated system generation processing 3-19 of FIG. 3 to recompile all modified client programs to rebuild a Web application program.

Next, the display processing unit 15-13 of the Web service client 15-12 starts the rebuilt Web application program and displays a Web page on the browser of the user PC 15-14 to receive an input from the browser through the communication device and hand it over to the SOAP message generation unit 15-5.

The SOAP message generation unit 15-5 of the Web service client 15-12 receives data entered from the browser of the user PC 15-14 through the display processing unit 15-13 to generate a SOAP message. At this time, the added input check script checks whether the input character string entered from the input device of the user PC 15-14 conforms to the transmittable characters and the transmitter character number stored in the check list of the CLDB 15-23 in the storage device. If the input character string fails to conform to the transmittable characters and the character number, the script issues a warning message, such as “input type is not valid.”

Next, the SOAP communication unit 15-3 sends the generated SOAP message in a test mode. This is done in the same way as in the test transmission processing 3-17 described earlier. That is, the unit 15-3 adds a mode tag to the header of the SOAP message and sends the SOAP message with the content of mode tag set to “TEST” to the Web service server 15-20. In this embodiment it is assumed that the Web service server 15-20 also has a function of interpreting this header. When the content of the mode tag is “TEST”, the Web service server 15-20 operates in the test mode and, without performing actual reservation and ordering operations, checks if the SOAP message sent from the client side is a normal input and returns a response to the message.

In the response analysis processing 3-21 the SOAP communication unit 15-3 either analyzes its response or, in the event of a failure to send the SOAP message due to an execution error, analyzes the error. If a normal response is sent back, the system operation is immediately resumed (3-22). But in the event of an execution error or if a response from the Web service server 15-20 is an error, the processing 3-21 notifies a content of the error to an administrator and stops the system operation (3-23).

As described above, in the event of an error caused by a change made to the interface definition information, the program management device of this embodiment performs a test transmission to identify an input type at the location of change and changes the program according to the content of change made to the interface definition information and the test result. Therefore, in the event of an error caused by a change made to the interface definition information, the program can be changed dynamically to prevent an occurrence of the similar error.

It should be further understood by those skilled in the art that although the foregoing description has been made on embodiments of the invention, the invention is not limited thereto and various changes and modifications may be made without departing from the spirit of the invention and the scope of the appended claims.

1. A program management method for changing a program according to a change made to interface definition information, the program management method comprising the steps of:
when a message is transmitted to an information processing device from a communication means, receiving a response from the destination information processing device by the communication means and checking whether an error has occurred which was caused by a change made to the interface definition information representing an interface with the information processing device;
in an event of an error caused by a change made to the interface definition information, test-transmitting to the information processing device from the communication means a message to identify an input type at a location of that change; and
according to the location of change and a result of test transmission, changing a content of a program on a memory means which transmits the messages to the information processing device.

2. A program management method according to claim 1, wherein an empty character string is test-transmitted as a content of a tag added at the location of change to the information processing device from the communication means to check whether the content of the tag is required or not at time of message transmission.

3. A program management method according to claim 1, wherein predetermined character kinds are test-transmitted as a content of a tag added at the location of change to the information processing device from the communication means to identify those characters that can be transmitted as the content of the tag at time of message transmission and information representing the transmittable characters is stored in a check list on the memory means.

4. A program management method according to claim 1, wherein a predetermined number of characters is test-transmitted as a content of a tag added at the location of change to the information processing device from the communication means to determine the number of characters that can be transmitted as the content of the tag at time of message transmission and information representing the transmittable number of characters is stored in a check list on the memory means.

5. A program management method according to claim 1, wherein predetermined values are test-transmitted as a content of a tag added at the location of change to the information processing device from the communication means to determine a range of values that can be transmitted as the content of the tag at time of message transmission and information representing the transmittable range of values is stored in a check list on the memory means.

6. A program management method according to claim 1, wherein a predetermined type of character string is test-transmitted as a content of a tag added at the location of change to the information processing device from the communication means to determine a type of characters that can be transmitted as the content of the tag at time of message transmission and information representing the transmittable type of character string is stored in a check list on the memory means.

7. A program management method according to claim 6, wherein, from the type of character string that is determined by the character type check to be transmittable, characters and the number of characters are extracted and information representing the transmittable characters and character number is stored in the check list on the memory means.

8. A program management method according to claim 1, wherein an input check script to check a content of a tag added at the location of change is added on the memory means to change a content of a program, which transmits the messages to the information processing device, according to a result of the test transmission.

9. A program management device for changing a program according to a change made to interface definition information, the program management device comprising:
a fault retrieval and analysis unit to, when a message is transmitted to an information processing device from a communication means, receive a response from the destination information processing device by the communication means and check whether an error has occurred which was caused by a change made to the interface definition information representing an interface with the information processing device;
a communication unit to, in the event of an error caused by a change made to the interface definition information, test-transmit to the information processing device from the communication means a message to identify an input type at a location of that change; and
a client program change unit to, according to the location of change and a result of test transmission, change a content of a program on a memory means which transmits the messages to the information processing device.

10. A program to cause a computer to execute a program management method that changes a program according to a change made to interface definition information, the program causing the computer to execute the steps of:
when a message is transmitted to an information processing device from a communication means, receiving a response from the destination information processing device by the communication means and checking whether an error has occurred which was caused by a change made to the interface definition information representing an interface with the information processing device;
in the event of an error caused by a change made to the interface definition information, test-transmitting to the information processing device from the communication means a message to identify an input type at a location of that change; and
according to the location of change and a result of test transmission, changing a content of a program on a memory means which transmits the messages to the information processing device.
